(19) United States
(12) Patent Application Publication
(10) Pub. No.: US 2007/0003153 A1
(43) Pub. Date: Jan. 4, 2007

(54) Method and apparatus for improved inverse transform calculation

(75) Inventor: Richard M. Miller-Smith, Oxted (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/573,738

(22) PCT Filed: Sep. 29, 2004
(86) PCT No.: PCT/IB04/51918

§ 371 Date: Mar. 28, 2006

(30) Foreign Application Priority Data
Oct. 2, 2003 (GB) 0323038.0

(51) Int. Cl. G06K 9/36

(52) U.S. Cl. 382/250

(57) ABSTRACT

A method is provided for determining, from DCT coded data used in MPEG video coding, the number of bits required to represent an output value which would be obtained after an inverse transform is performed on said transform coded data. The method comprises obtaining a sum of coefficient values within said transform coded data (204) and comparing this sum to a predetermined threshold value (206). As a consequence of said comparison a processor decides which inverse transform implementation, out of a number of pre-determined implementations, should be performed when decoding said transform-coded (208,210). For example, eight bit-processing routines may be used, which are more economic than nine bit routines if the sum is less than a threshold value.

The invention relates to a method and associated apparatus for enabling efficient inverse transform calculation and, in particular, to using such a method in MPEG (Moving Picture Expert Group) video processing using an inverse discrete cosine transform (IDCT).

A two-dimensional 8×8 discrete cosine transform (DCT) is used at the heart of MPEG video decoding.

MPEG decoding includes several parts such as variable length decoding, the IQ/IDCT stage and the motion reconstruction phase. The IQ and IDCT phase is used in two ways, one way is in so called ‘Intra’ macroblocks where the output image values are described directly by the output of the IDCT, the other is in ‘non-Intra’ or ‘Inter’ macroblocks where the IDCT output is used as a corrective term by the addition of the output on top of the motion reconstruction.

The inverse quantisation (IQ) stage turns the values coded in the bitstream into values ready for input to the inverse DCT transformation.

A number of methods to quickly calculate both the DCT (used during encode) and inverse-DCT (used during decode) have been published. However, these describe mathematical methods to calculate the result quickly—this patent application describes an approach that takes in to account particular characteristics of the IDCT input and output data as found in an MPEG video stream.

In Intra-frames the output range of the IDCT is zero to 255, which is equal to the output range of the pixel values in the picture. This can be held in an eight bit unsigned binary number.

In non-Intra frames the output range of the IDCT is −256 to 255, which has to be held in at least a nine bit signed binary number. However, in practice it is found that greater than 99% of IDCT output values are within the smaller range −128 to 127. This can be held in eight bits. IDCT with output values in this range have the advantage that on media processors such as TriMedia®, and on standard processors with media extensions such as the Pentium® and Athlon® families, there are optimised instructions that quickly allow the handling of multiple eight bit values in longer words. The inventors have recognised that it would be possible to use such economic processing much of the time, if one could predict in advance whether a block of transform coefficients can be processed without any results exceeding the range 0-255.

Therefore it is an object of the invention to enable optimised processor usage in inverse transform and similar operations and in particular to devise a test which can predict, very simply, whether all output values are capable of 8 bit representation. The test should require very little CPU effort such that the processing economy achieved is not cancelled out by the effort of doing the test

The invention provides a method of determining, from transform coded data, the number of bits required to represent an output value which would be obtained as a result of an inverse transform being performed on said transform coded data, said method comprising the steps of obtaining a sum of coefficient values within said transform coded data and comparing this sum to a pre-determined threshold value.

Said method may include the further step of: deciding as a consequence of said comparison which inverse transform implementation, out of a number of pre-determined implementations, should be performed when decoding said transform coded data.

Said transform coded data may be discrete cosine transform (DCT) coded data, for example as part of MPEG-1 or MPEG-2 encoded video data.

The test may be used to determine whether said output values can be represented in eight bits, or require nine-bit representation. In this case said inverse transform implementations may include one or some with optimised instructions to allow efficient handling of multiple eight-bit values in longer words.

When the coefficient values are bi-polar, said sum may be the absolute values of the coefficients. The appropriate level of the threshold can be determined from the mathematical definition of the transform in question.

In a preferred embodiment the input consists of an 8×8 discrete cosine transform. In this case it can be shown that the output will be capable of eight bit representation if said sum is less than the pre-determined value which is less than or equal to 528. In practical implementations it may be preferred that this predetermined value is set lower than 528, for example at 524, to allow for error in the IDCT implementation. The threshold may be in the range 500 to 528 preferably, without losing most the benefit of the invention. If the threshold is set too low, the only consequence is that blocks will be processed by less efficient code, that could be processed by more efficient code. If the threshold is set too high, by contrast, erroneous outputs, or overflow errors could result.

In a further aspect of the invention there is provided apparatus suitable for carrying out the steps of the method described above.

In a yet further aspect of the invention there is provided a record carrier wherein are recorded program instructions for causing a programmable processor to perform the steps of the method described above.

Embodiments of the invention will now be described, by way of example only, by reference to the accompanying drawings, in which:

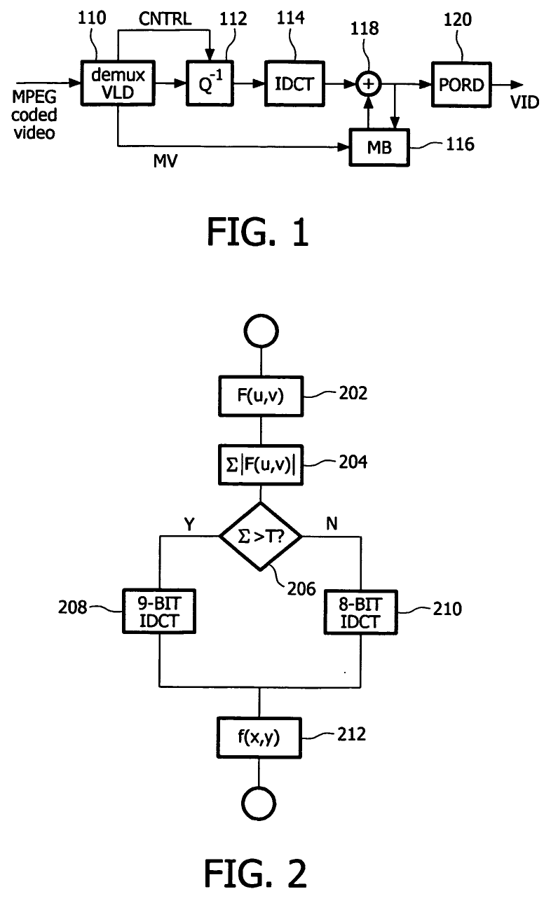

FIG. 1 shows a block diagram of an MPEG decoder;

FIG. 2 is a flowchart of a method of an inverse transform process according to an embodiment of the present invention;

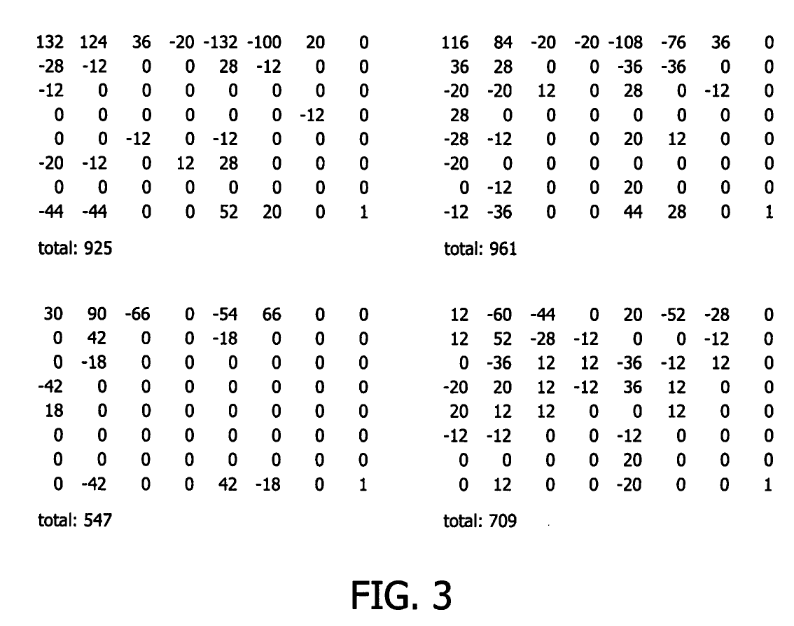

FIG. 3 shows a number of examples of blocks of DCT coefficients with totals above a threshold value; and

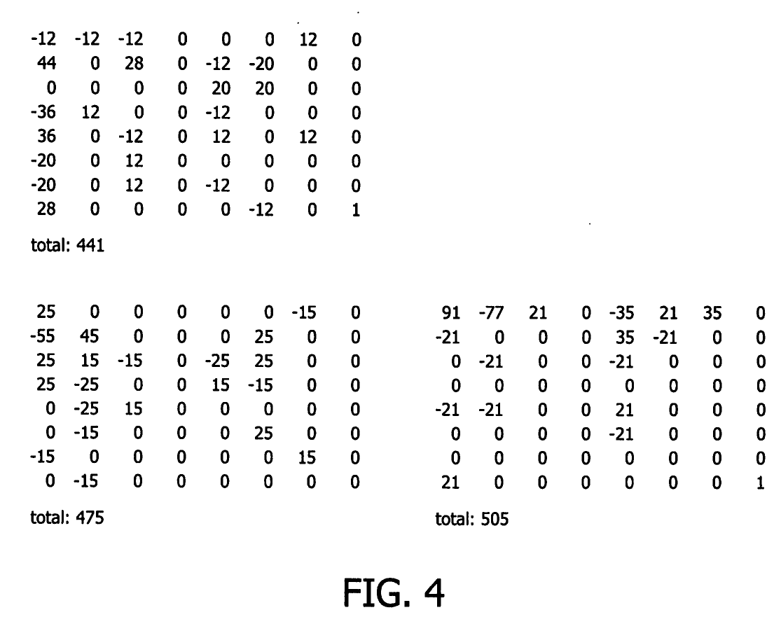

FIG. 4 shows a number of examples of blocks of DCT coefficients with totals below a threshold value

FIG. 1 shows an MPEG decoder as used in an embodiment of the invention. The decoder consists of the functions: variable length decoder (VLD) 110, inverse quantizer 112, inverse discrete cosine transform (IDCT) process 114, motion buffer 116, summing process 118, and a picture ordering process 120. The decoder in this example is implemented by suitable programming of a specialised microprocessor, such as are available from Trimedia, although other processors could be used, as mentioned in the introduction. It is also possible to provide dedicated hardware to perform one or more of these functions.

Conventionally, the MPEG encoded video is fed into VLD 110 (often via a buffer (not shown)) and decoded into quantized DCT coefficients, which are then inverse quantized by the inverse quantizer 112. The DCT coefficients are then fed into the IDCT process 114, which performs an inverse digital cosine transform on the coefficients thus outputting the spatial pixel data. This is sent either directly to the picture ordering process 120, if an intra frame. If not an intra frame, there is motion compensation provided by the motion buffer 116 and summing process 118. The present description concerns only the IDCT process 114, and the other functions of the decoder will not be discussed further.

The output of the non-Intra IDCT should be clipped to the range −256 to 255, this being a consequence of the MPEG specification, which forces each output value to be clipped to this range. However, in order to implement the optimal IDCT process 114 using special operations available on media processors it would be desirable to discover which blocks of input values to the IDCT produce output values in the range that can be represented by an eight bit signed value (−128 to 127).

A simple test is described which ensures that all IDCTs blocks that 25 require a nine-bit range are found, while the vast majority of IDCTs are done with the shorter eight bit version. This test calculates the sum of the absolute values of the input coefficients of the IDCT process. If this is greater than or equal to a pre-determined value then the full nine-bit implementation of the IDCT is done. If the sum is less than the value then the optimal, eight-bit version is used.

For the MPEG standard IDCT, the inventors have determined that this pre-determined figure is 508, as shown below. In these equations f(x,y) represents the desired output value at position (x,y) in a block of pixels F(u,v) represents the coefficient values at positions (u,v) within the corresponding block of DCT coefficients, received from the inverse quantizer 112. The formula for the 2-dimensional inverse DCT as used in MPEG2 is:

$$f ( x , y ) = \frac{2}{N} {\sum }_{u = 0}^{N - 1} {\sum }_{v = 0}^{N - 1} C ( u ) C ( v ) F ( u , v ) cos \frac{( 2 x + 1 ) u π}{2 N} cos \frac{( 2 y + 1 ) v π}{2 N}$$

where x,y=0,1,2, . . . N-1

and

$$C ( z ) = \{ \begin{matrix}\frac{1}{\sqrt{2}} for z = 0 \\ 1 otherwise\end{matrix}$$

It can be seen that this represents a weighted sum of all the coefficients. For the 8×8 case this can be re-written as:

$$f ( x , y ) = \frac{1}{4} {\sum }_{u = 0}^{7} {\sum }_{v = 0}^{7} C ( u ) C ( v ) F ( u , v ) cos \frac{( 2 x + 1 ) u π}{2 N} cos \frac{( 2 y + 1 ) v π}{2 N}$$

$$or$$

$$f ( x , y ) = \frac{1}{4} {\sum }_{u = 0}^{7} {\sum }_{v = 0}^{7} X ( u , v , x , y ) F ( u , v )$$

$$where$$

$$X ( u , v , x , y ) = C ( u ) C ( v ) cos \frac{( 2 x + 1 ) u π}{2 N} cos \frac{( 2 y + 1 ) v π}{2 N}$$

It can be seen that X(u,v) is always within the range −1 to 1, as all its factors are within this range.

Consequently, it is known that the absolute value of X(u,v) is less than or equal to one. Taking the absolute value we have:

$$abs ( f ( x , y ) ) = \frac{1}{4} {\sum }_{u = 0}^{7} {\sum }_{v = 0}^{7} abs ( X ( u , v , x , y ) ) abs ( F ( u , v ) )$$

$$Which means that \text{:}$$

$$\frac{1}{4} {\sum }_{u = 0}^{7} {\sum }_{v = 0}^{7} abs ( X ( u , v , x , y ) ) abs ( F ( u , v ) ) < \frac{1}{4} {\sum }_{u = 0}^{7} {\sum }_{v = 0}^{7} abs ( F ( u , v ) )$$

$$i . e . \\ abs ( f ( x , y ) ) < \frac{1}{4} {\sum }_{u = 0}^{7} {\sum }_{v = 0}^{7} abs ( F ( u , v ) )$$

Therefore, if the sum of the absolute values of the input coefficients is less than four times a certain value, then the actual output value must also be less than the specified value.

For the eight bit clipping test, the absolute value of the output is 1o required to be less than 127. Therefore, taking into account the overall scaling of one quarter, we know that if the sum of absolute values is less than 508 then the output can be represented in eight bits.

On closer inspection it can be found that the X(u,v,x,y) is in the range −(cos(π/16))² to +(cos(π/16))², which is approximately −0.9619 to 0.9619. This means the range can be expanded:

$$\frac{1}{4} {\sum }_{u = 0}^{7} {\sum }_{v = 0}^{7} abs ( X ( u , v , x , y ) ) abs ( F ( u , v ) ) \leq \frac{{( cos ( \frac{π}{16} ) )}^{2}}{4} {\sum }_{u = 0}^{7} {\sum }_{v = 0}^{7} abs ( F ( u , v ) )$$

$$i . e . \\ abs ( f ( x , y ) ) \leq \frac{{( cos ( \frac{π}{16} ) )}^{2}}{4} {\sum }_{u = 0}^{7} {\sum }_{v = 0}^{7} abs ( F ( u , v ) )$$

Therefore to ensure that the absolute value of any output coefficient is less than or equal to 127, the sum of the absolute values of the input must be less than 528 (i.e. 127 multiplied by four, divided by (cos(π/16))²).

However, it should be noted that this assumes a perfect IDCT implementation. Consequently, to allow for error values a threshold value of about 524 is safer to use in practice.

FIG. 2 shows a flowchart illustrating the above method. Step 202 represents the initial step of obtaining all the coefficient values. At step 204 the sum of the absolute values of these coefficients is obtained. At step 206 this sum is compared to a threshold value. If this sum is greater than the threshold value then at step 208, the full 9-bit IDCT implementation is undertaken. However, if the sum is less than the threshold value then at step 210 an optimized 8-bit IDCT implementation is used. Finally, at step 212 the output value is calculated.

FIGS. 3 and 4 show a number of examples of blocks of DCT coefficients and the corresponding sum of their absolute values. FIG. 3 shows examples were the sum is above the threshold limit, and therefore the 9-bit IDCT implementation will be required. FIG. 4 shows examples were the sum is below the threshold and consequently the optimized 8-bit implementation can be used.

It should be noted that the foregoing description gives examples only, and other examples and embodiments are envisaged without departing from the spirit and scope of the invention. In particular, although examples for an 8×8 DCT with eight-bit coefficients are given, it can be envisaged that this method can be used with transforms of other sizes and types, the skilled person now being enabled to derive a suitable threshold value using the above disclosure. It should also be noted that the invention can be applied in the forward transform steps and not just the inverse transform steps to determine if any output value is over a certain value.

1. A method of determining, from transform coded data, the number of bits required to represent an output value which would be obtained as a result of an inverse transform being performed on said transform coded data, said method comprising the steps of obtaining a sum of coefficient values within said transform coded data (204) and comparing this sum to a pre-determined threshold value (206).

2. A method as claimed in claim 1 wherein said transform coded data is discrete cosine transform (DCT) coded data

3. A method as claimed in claim 1 wherein said transform coded data is MPEG-1 or MPEG-2 encoded video data.

4. A method as claimed in claim 1 wherein said method is used to determine whether said output values can be represented in eight bits, or require nine bit representation.

5. A method as claimed in claim 1 wherein said method includes the further step of: deciding as a consequence of said comparison which inverse transform implementation, out of a number of pre-determined implementations, should be performed when decoding said transform coded data (208,210).

6. A method as claimed in claim 5 wherein at least one of said inverse transform implementations includes instructions for handling of multiple eight bit values in longer words.

7. A method as claimed in any preceding claim 1 wherein the coefficient values are bi-polar, and said sum is of the absolute values of the coefficients.

8. A method as claimed in claim 1 wherein the transform coded data consists of an 8×8 discrete cosine transform.

9. A method as claimed in claim 8 wherein said pre-determined threshold value is in the range 500 to 530.

10. Apparatus for determining, from transform coded data, the number of bits required to represent an output value which would be obtained as a result of an inverse transform being performed on said transform coded data, said apparatus comprising means for obtaining a sum of coefficient values within said transform coded data and means for comparing this sum to a pre-determined threshold value.

11. Apparatus as claimed in claim 10 wherein said transform coded data is discrete cosine transform (DCT) coded data.

12. Apparatus as claimed in claim 10 wherein said transform coded data is MPEG-1 or MPEG-2 encoded video data.

13. Apparatus as claimed in claim 10 wherein said apparatus is suitable for to determining whether said output values can be represented in eight bits, or require nine bit representation.

14. Apparatus as claimed in claim 10 wherein there is further provided means for deciding as a consequence of said comparison which inverse transform implementation, out of a number of pre-determined implementations, should be performed when decoding said transform coded data.

15. Apparatus as claimed in claim 14 wherein at least one of said inverse transform implementations includes instructions for handling of multiple eight bit values in longer words.

16. Apparatus as claimed in claim 10 wherein the coefficient values are bi-polar, and said sum is of the absolute values of the coefficients.

17. Apparatus as claimed in claim 10 wherein the transform coded data consists of an 8×8 discrete cosine transform.

18. Apparatus as claimed in claim 17 wherein said pre-determined threshold value is in the range 500 to 530.

19. A record carrier wherein are recorded program instructions for causing a programmable processor to perform the steps of the method as claimed in claim 1.
